(19) United States
(12) Patent Application Publication
(10) Pub. No.: US 2024/0417251 A1
(43) Pub. Date: Dec. 19, 2024

(54) PROCESS FOR PRODUCING ULTRA-LOW TO NEGATIVE CARBON HYDROGEN

(71) Applicant: L'Air Liquide, Societe Anonyme pour l'Etude et l’Exploitation des Procedes Georges Claude, Paris (FR)

(72) Inventors: Regis REAU, Jouy-en-Josas (FR); Robert GAGLIANO, Houston, TX (US); Pavol PRANDA, Houston, TX (US); Claire BAROU, Houston, TX (US); Andres RAYA-IMBERNON, Frankfurt am Main (DE)

(73) Assignee: L'Air Liquide, Societe Anonyme pour l'Etude et l’Exploitation des Procedes Georges Claude, Paris (FR)

(21) Appl. No.: 18/742,768

(22) Filed: Jun. 13, 2024

Related U.S. Application Data
(60) Provisional application No. 63/521,137, filed on Jun. 15, 2023.

(51) Int. Cl. C01B 3/48; B01D 53/047; C01B 3/36; C01B 3/56

(52) U.S. Cl. CPC C01B 3/48; B01D 53/047; C01B 3/36; C01B 3/56; B01D 2256/16; B01D 2257/504; C01B 2203/0233; C01B 2203/0244; C01B 2203/0283; C01B 2203/043; C01B 2203/0475; C01B 2203/84

(57) ABSTRACT

A method for producing ultra-low carbon hydrogen, including producing a flue gas stream, a raw syngas stream, and a high-pressure steam stream in a syngas generator, introducing the flue gas stream into a point-source carbon capture unit, thereby producing a clean flue gas stream and a first carbon dioxide stream, introducing an ambient air stream into a direct air carbon capture unit, thereby producing a clean air stream and a second carbon dioxide stream, and combining the first carbon dioxide stream and the second carbon dioxide stream and storing the combined carbon dioxide stream. The method may also include introducing the high-pressure steam stream into a steam turbine generator, thereby producing electrical power. The method may also include utilizing at least a portion of the electrical power in the direct air carbon capture unit.

### CROSS REFERENCE TO RELATED APPLICATIONS

This application claims the benefit of priority under 35 U.S.C. § 119 (a) and (b) to U.S. Provisional Patent Application No. 63/521,137, filed Jun. 15, 2023, the entire contents of which are incorporated herein by reference.

### BACKGROUND

Hydrogen is required for a number of commercial and industrial purposes but does not exist naturally in large quantities as a raw material. Accordingly, processes have been derived for producing hydrogen from other raw materials. One such process is the production of hydrogen from natural gas. Compared with other fossil fuels, natural gas is a cost-effective feed for making hydrogen, in part because it is widely available and easily managed.

Specifically, the majority of hydrogen produced from natural gas today is by means of the steam methane reforming process. This involves steam and natural gas being passed at high temperature over a catalyst to produce a gas stream, of which a large part is hydrogen. The endothermic heat of reaction is traditionally supplied by combustion of a suitable fuel such as natural gas or off-gases from hydrogen separation processes at, or about, atmospheric pressure.

As a byproduct of the production of the hydrogen-containing gas stream, a considerable amount of useful heat is produced. This useful heat is found in the hydrogen-containing gas stream itself and in the resulting hot flue gas stream. In a typical industrial facility, one or both of these gas streams are used to produce steam. The steam reforming process itself consumes a considerable amount of this steam, but most of the time excess steam is generated. If there is no additional local demand for steam, disposal of this excess steam may represent a systemic inefficiency. The instant inventive process provides a very efficient utilization of this excess steam.

As the issue of global warming and the perceived contribution of carbon dioxide emissions to this is currently a very important topic of discussion, when considering the use of natural gas or other hydrocarbon feedstocks to produce hydrogen, the capture and disposition of carbon dioxide needs consideration.

In one approach, carbon dioxide present in the gaseous exhaust stream from the production of electricity from natural gas or other hydrocarbon feedstocks can be at least partially removed by passing it through a solvent to capture carbon dioxide. However, this technique has significant cost and energy penalties and there is a need to dispose of degradation/by-products from the solvent.

In addition to the use of solvents, alternative point source carbon capture (PSCC) approaches have been developed, which include, but are not limited to, sorbents, membranes, and cryogenic separation.

Turning to FIG. 1, a typical hydrogen plant as is known in the art is presented. In one embodiment, fuel gas stream 101 enters synthesis generator 102. In another embodiment fuel gas stream 101 may be blended with off-gas recycle stream 113, and the combined stream enters synthesis gas generator 102. Water (or steam) stream 103 and process feed stream 104 also enter synthesis gas generator 102, thereby producing raw flue gas stream 105, raw synthesis gas stream 106, and high-pressure steam stream 107. Synthesis generator 102 may be a steam methane reformer (SMR) or an autothermal reformer (ATR).

Raw synthesis gas stream 106 enters water-gas shift converter 108, thereby producing shifted synthesis gas stream 109. Shifted synthesis gas stream 109 then enters pressure swing adsorption unit 110, thereby producing hydrogen stream 111, off-gas stream 112 and (optionally) off-gas recycle stream 113.

Raw flue gas stream 105 is blended with off-gas stream 112, thereby producing combined flue gas stream 114. Combined flue gas stream 114 is then introduced into point source carbon capture unit (PCCS) 115, thereby producing carbon dioxide stream 116 and clean flue gas stream 117.

In such a typical hydrogen plant, the PCCS unit captures much of the carbon dioxide that would otherwise be released into the atmosphere. The captured carbon dioxide can then be used in an industrial application or sequestered. However, as efficient as these systems may be, they can only result in a partial reduction in carbon footprint.

As environmental pressures are increasing, and emission requirements are becoming more onerous, there is a need in the industry for an improved process of hydrogen production that results in ultra-low to negative carbon release into the atmosphere.

### SUMMARY

A method for producing ultra-low carbon hydrogen, including producing a flue gas stream, a raw syngas stream, and a high-pressure steam stream in a syngas generator, introducing the flue gas stream into a point-source carbon capture unit, thereby producing a clean flue gas stream and a first carbon dioxide stream, introducing an ambient air stream into a direct air carbon capture unit, thereby producing a clean air stream and a second carbon dioxide stream, and combining the first carbon dioxide stream and the second carbon dioxide stream and storing the combined carbon dioxide stream. The method may also include introducing the high-pressure steam stream into a steam turbine generator, thereby producing electrical power. The method may also include utilizing at least a portion of the electrical power in the direct air carbon capture unit.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation a process of removing carbon dioxide from hydrogen, as known in the art.

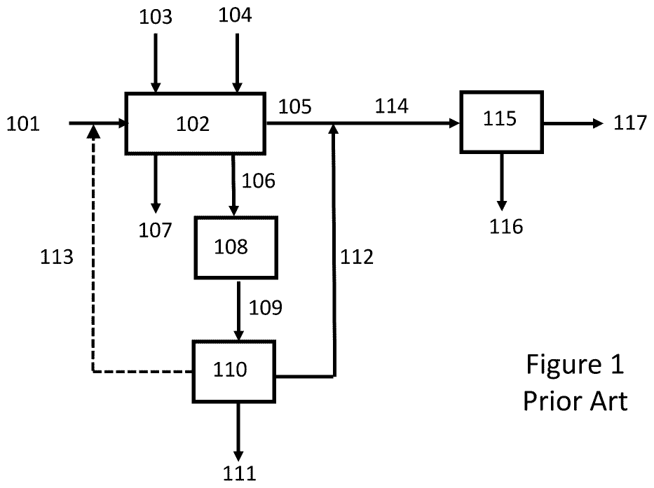

FIG. 2 is a schematic representation of a process of removing carbon dioxide from hydrogen, utilizing a DAC that is powered 100% with electricity, accordance with one embodiment of the present invention.

FIG. 3 is a schematic representation of a process of removing carbon dioxide from hydrogen, utilizing a DAC that is powered with both electricity and high-pressure steam, incorporating a condensing steam turbine, accordance with one embodiment of the present invention.

FIG. 4 is a schematic representation of a process of removing carbon dioxide from hydrogen, utilizing a DAC that is powered with both electricity and low-pressure steam from a backpressure steam turbine, accordance with one embodiment of the present invention.

### ELEMENT NUMBERS

101=fuel gas stream
102=synthesis gas generator
103=water or steam
104=process feed stream
105=raw flue gas stream
106=raw synthesis gas stream 107=
107=high-pressure steam stream
108=water-gas shift converter
109=shifted synthesis gas stream
110=pressure swing adsorption unit
111=hydrogen stream
112=off-gas stream
113=off-gas recycle stream
114=combined flue gas stream
115=point source carbon capture unit (PCCS) 115
116=carbon dioxide stream
117=clean flue gas stream
201=fuel gas stream
202=synthesis gas generator
203=water or steam
204=process feed stream
205=raw flue gas stream
206=raw synthesis gas stream 107=
207=high-pressure steam stream
208=water-gas shift converter
209=shifted synthesis gas stream
210=pressure swing adsorption unit
211=hydrogen stream
212=off-gas stream
213=off-gas recycle stream
214=combined flue gas stream
215=point source carbon capture unit (PCCS)
216=first carbon dioxide stream
217=clean flue gas stream
219=inlet air stream
220=electrical power
221=direct air capture unit (DAC)
222=clean air stream
223=second carbon dioxide stream
224=carbon dioxide storage
225=steam turbine generator
226=electrical generator
227=low-pressure steam
228=condenser
301=fuel gas stream
302=synthesis gas generator
303=water or steam
304=process feed stream
305=raw flue gas stream
306=raw synthesis gas stream 107=
307=high-pressure steam stream
308=water-gas shift converter
309=shifted synthesis gas stream
310=pressure swing adsorption unit
311=hydrogen stream
312=off-gas stream
313=off-gas recycle stream
314=combined flue gas stream
315=point source carbon capture unit (PCCS)
316=first carbon dioxide stream
317=clean flue gas stream
319=inlet air stream
320=electrical power
321=direct air capture unit (DAC)
322=clean air stream
323=second carbon dioxide stream
324=carbon dioxide storage
325=steam turbine generator
326=electrical generator
327=low-pressure steam
328=condenser
329=steam stream to DAC
401=fuel gas stream
402=synthesis gas generator
403=water or steam
404=process feed stream
405=raw flue gas stream
406=raw synthesis gas stream 107=
407=high-pressure steam stream
408=water-gas shift converter
409=shifted synthesis gas stream
410=pressure swing adsorption unit
411=hydrogen stream
412=off-gas stream
413=off-gas recycle stream
414=combined flue gas stream
415=point source carbon capture unit (PCCS)
416=first carbon dioxide stream
417=clean flue gas stream
419=inlet air stream
420=electrical power
421=direct air capture unit (DAC)
422=clean air stream
423=second carbon dioxide stream
424=carbon dioxide storage
425=steam turbine generator
426=electrical generator
427=low-pressure steam
428=condenser

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The instant invention relates to a process that produces ultra-low to negative carbon hydrogen from hydrocarbons (typically natural gas) via a Steam-Methane Reforming (SMR) or Auto-thermal Reforming (ATR) unit. The inventive process utilizes a point-source carbon capture (PSCC) unit (or units) that is used to capture emissions from either the process stream and/or the combustion stream both of which contain CO₂ emissions. This CO₂ is typically present in the flue gas, PSA off gas and/or downstream of the water-shift reaction. This results in a reduction in greenhouse gas (GHG) intensity of the fossil based H₂.

In this system, a direct air carbon capture (DAC) unit is also used to capture CO₂ from ambient air. This allows the entire system to offset close to 100% or more of the residual CO₂ equivalent emissions of the fossil based H₂ not covered by the PSCC system. In the present system almost 100% of the energy requirements of the DAC process are covered by the energy supplied from co-produced steam of the SMR or ATR process.

Direct air carbon capture (DAC) systems are known in the art, but almost exclusively utilize large quantities of steam, typically low-pressure steam. Often deliberate efforts must be made to produce and provide this steam thereby partially negating the overall carbon dioxide reduction impact of the system.

In addition, a steam turbine may be used to convert the SMR/ATR co-produced steam to (a) electricity and condensate water or (b) down-graded steam and electricity to match DAC energy input requirements. The captured CO₂ from both DAC and PSCC systems are transported as liquid, supercritical or gaseous form and eventually stored in a durable and long-term manner (geological sequestration or long-lived products).

Such a scheme will work on a retrofitting application (adding components to existing SMR/ATR assets with or without PSCCS) or will work for a brand-new designed all-in-one asset.

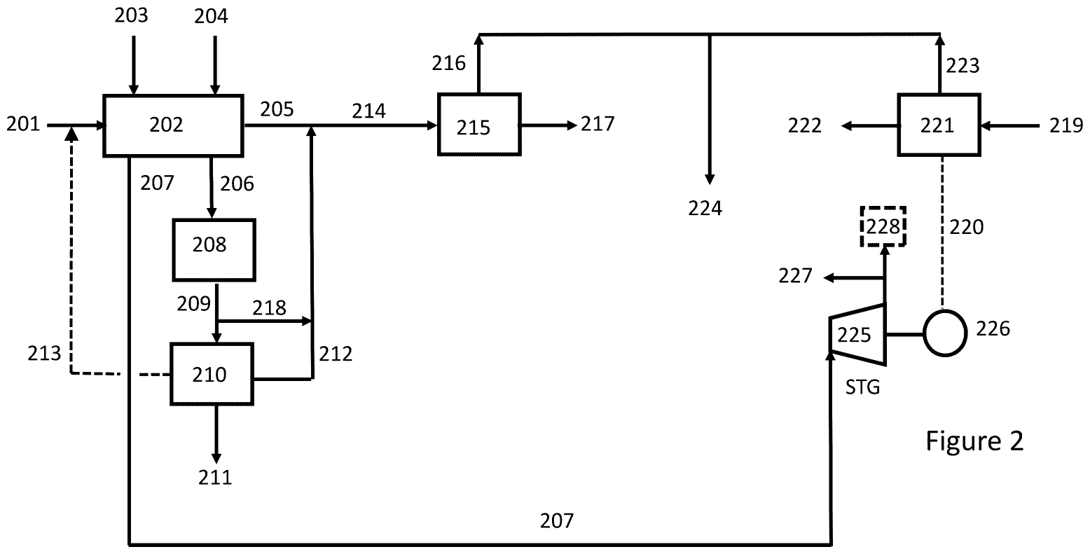

Turning to FIG. 2, a hydrogen plant in accordance with one embodiment of the present invention is provided. In one embodiment, fuel gas stream 201 enters synthesis gas generator 202. In another embodiment fuel gas stream 201 may be blended with off-gas recycle stream 213, and the combined stream enters synthesis gas generator 202. Water (or steam) stream 203 and process feed stream 204 also enter synthesis gas generator 202, thereby producing raw flue gas stream 205, raw synthesis gas stream 206, and high-pressure steam stream 207. Synthesis generator 202 may be a steam methane reformer (SMR) or an autothermal reformer (ATR).

Raw synthesis gas stream 206 enters water-gas shift converter 208, thereby producing shifted synthesis gas stream 209. At least a portion of shifted synthesis gas stream 109 then enters pressure swing adsorption unit 210, thereby producing hydrogen stream 211, off-gas stream 212 and (optionally) off-gas recycle stream 213. Another portion of shifted synthesis gas stream 209 is then mixed with off-gas stream 212, and the mixed stream is combined with raw flue gas stream 205, thereby producing combined flue gas stream 214. Combined flue gas stream 214 is then introduced into point source carbon capture unit (PCCS) 215, thereby producing first carbon dioxide stream 216 and clean flue gas stream 217.

At least a portion of high-pressure steam stream 207 is introduced into steam turbine generator 225, which is mechanically attached to electrical generator 226, thereby producing electrical power 220. Steam turbine generator 225 may be a condensing-type steam turbine, in which case low-pressure steam 227 at the exhaust is introduced into condenser 228. Steam turbine generator 225 may be a back-pressure type steam turbine, in which case low-pressure stream 227 will be utilized in a downstream process (not shown).

Inlet air stream 219, along with electrical power 220, are introduced into direct air capture unit (DAC) 221, thereby producing clean air stream 222 and second carbon dioxide stream 223. First carbon dioxide stream 216 is combined with second carbon dioxide stream 223, and the combined carbon dioxide stream is sent to carbon dioxide storage 224.

In such a typical hydrogen plant, the PCCS unit captures much of the carbon dioxide that would otherwise be released into the atmosphere. The captured carbon dioxide can then be used in an industrial application or sequestered. As environmental pressures are increasing, and emission requirements are becoming more onerous, there is a need in the industry for an improved system for even further reducing the net carbon emissions, to very low or net zero levels.

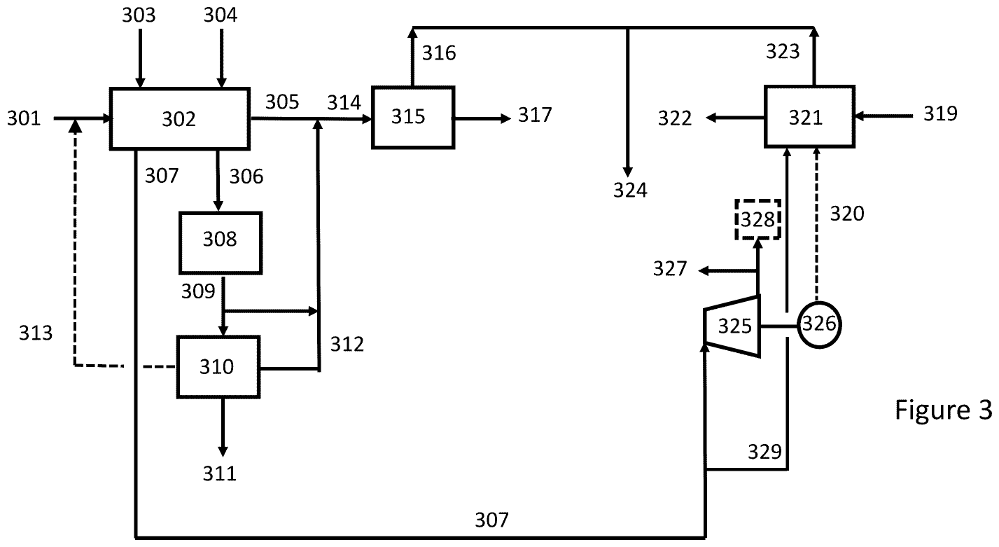

Turning to FIG. 3, a hydrogen plant in accordance with another embodiment of the present invention is provided. In one embodiment, fuel gas stream 301 enters synthesis gas generator 302. In another embodiment fuel gas stream 301 may be blended with off-gas recycle stream 313, and the combined stream enters synthesis gas generator 302. Water (or steam) stream 303 and process feed stream 304 also enter synthesis gas generator 302, thereby producing raw flue gas stream 305, raw synthesis gas stream 306, and high-pressure steam stream 307. Synthesis generator 302 may be a steam methane reformer (SMR) or an autothermal reformer (ATR).

Raw synthesis gas stream 306 enters water-gas shift converter 308, thereby producing shifted synthesis gas stream 309. At least a portion of shifted synthesis gas stream 309 then enters pressure swing adsorption unit 310, thereby producing hydrogen stream 311, off-gas stream 312 and (optionally) off-gas recycle stream 313. Another portion of shifted synthesis gas stream 309 is then mixed with off-gas stream 312, and the mixed stream is the combined with raw flue gas stream 305, thereby producing combined flue gas stream 314. Combined flue gas stream 314 is then introduced into point source carbon capture unit (PCCS) 315, thereby producing first carbon dioxide stream 316 and clean flue gas stream 317.

At least a portion of high-pressure steam stream 307 is introduced into steam turbine generator 325, which is mechanically attached to electrical generator 326, thereby producing electrical power 320. Steam turbine generator 325 may be a condensing-type steam turbine, in which case low pressure steam 327 at the exhaust is introduced into condenser 328. Steam turbine generator 325 may be a back-pressure type steam turbine, in which case low pressure stream 327 will be utilized in a downstream process (not shown).

Another portion 329 of high-pressure steam stream 307, along with inlet air stream 319, and electrical power 320, are introduced into direct air capture unit 321, thereby producing clean air stream 322 and second carbon dioxide stream 323. First carbon dioxide stream 316 is combined with second carbon dioxide stream 323, and the combined carbon dioxide stream is sent to storage 324.

In such a typical hydrogen plant, the PCCS unit captures much of the carbon dioxide that would otherwise be released into the atmosphere. The captured carbon dioxide can then be used in an industrial application or sequestered. As environmental pressures are increasing, and emission requirements are becoming more onerous, there is a need in the industry for an improved system for even further reducing the net carbon emissions, to very low or net zero levels.

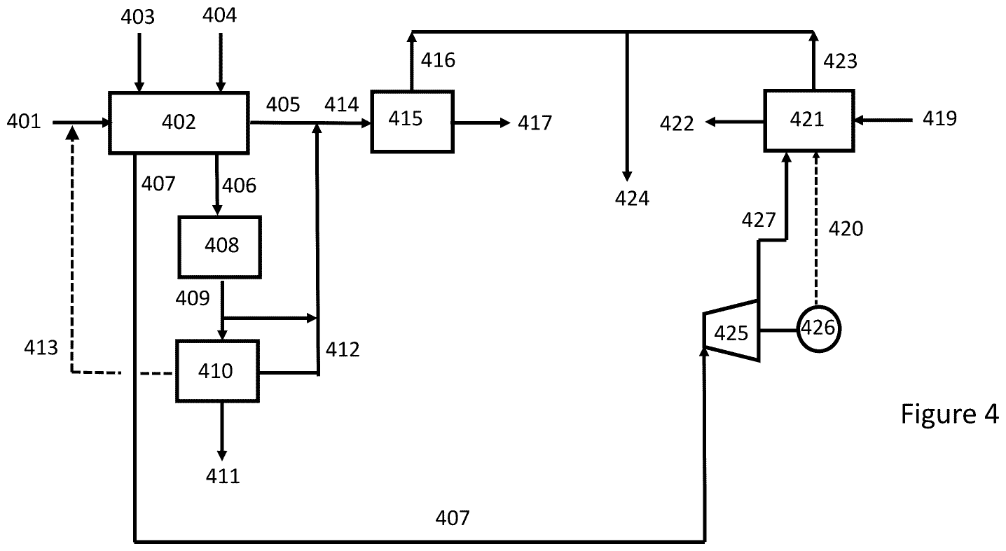

Turning to FIG. 4, a hydrogen plant in accordance with another embodiment of the present invention is provided. In one embodiment, fuel gas stream 401 enters synthesis gas generator 402. In another embodiment fuel gas stream 401 may be blended with off-gas recycle stream 413, and the combined stream enters synthesis gas generator 402. Water (or steam) stream 403 and process feed stream 404 also enter synthesis gas generator 402, thereby producing raw flue gas stream 405, raw synthesis gas stream 406, and high-pressure steam stream 407. Synthesis generator 402 may be a steam methane reformer (SMR) or an autothermal reformer (ATR).

Raw synthesis gas stream 406 enters water-gas shift converter 408, thereby producing shifted synthesis gas stream 409. At least a portion of shifted synthesis gas stream 409 then enters pressure swing adsorption unit 410, thereby producing hydrogen stream 411, off-gas stream 412 and (optionally) off-gas recycle stream 413. Another portion of shifted synthesis gas stream 409 is then mixed with off-gas stream 412, and the mixed stream is the combined with raw flue gas stream 405, thereby producing combined flue gas stream 414. Combined flue gas stream 414 is then introduced into point source carbon capture unit (PCCS) 415, thereby producing first carbon dioxide stream 416 and clean flue gas stream 417.

At least a portion of high-pressure steam stream 407 is introduced into steam turbine generator 425, which is mechanically attached to electrical generator 426, thereby producing electrical power 420. Steam turbine generator 425 is a back-pressure type steam turbine thereby producing low-pressure steam stream 427.

At least a portion of low-pressure steam stream 427, along with inlet air stream 419, and electrical power 420, are introduced into direct air capture unit 421, thereby producing clean air stream 422 and second carbon dioxide stream 423. First carbon dioxide stream 416 is combined with second carbon dioxide stream 423, and the combined carbon dioxide stream is sent to storage 424.

In such a typical hydrogen plant, the PCCS unit captures much of the carbon dioxide that would otherwise be released into the atmosphere. The captured carbon dioxide can then be used in an industrial application or sequestered. As environmental pressures are increasing, and emission requirements are becoming more onerous, there is a need in the industry for an improved system for even further reducing the net carbon emissions, to very low or net zero levels.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for producing ultra-low carbon hydrogen, comprising:
producing a flue gas stream, a raw syngas stream, and a high-pressure steam stream in a syngas generator,
introducing the flue gas stream into a point-source carbon capture unit, thereby producing a clean flue gas stream and a first carbon dioxide stream,
introducing an ambient air stream into a direct air carbon capture unit, thereby producing a clean air stream and a second carbon dioxide stream, and
combining the first carbon dioxide stream and the second carbon dioxide stream and storing the combined carbon dioxide stream.

2. The method of claim 1, further comprising introducing the high-pressure steam stream into a steam turbine generator, thereby producing electrical power.

3. The method of claim 2, wherein at least a portion of the electrical power is used by the direct air carbon capture unit.

4. The method of claim 2, wherein the steam turbine generator comprises a condensing steam turbine.

5. The method of claim 2, wherein the steam turbine generator comprises a back-pressure steam turbine, thereby producing a low-pressure steam stream.

6. The method of claim 5, wherein at least a portion of the low-pressure steam stream is introduced into the direct air carbon capture unit.

7. The method of claim 2, wherein at least a portion of the high-pressure steam stream is introduced into the direct air carbon capture unit.

8. The method of claim 1, further comprising:
introducing the raw syngas stream into a water-gas shift converter, thereby producing a shifted syngas stream,
wherein at least a portion of the shifted syngas stream is combined with the flue gas stream prior to being introduced into the point-source carbon capture unit.

9. The method of claim 1, further comprising:
introducing the raw syngas stream into a pressures wing adsorption unit, thereby producing a product hydrogen stream and a PSA off-gas stream,
wherein at least a portion of the PSA off-gas stream is combined with the flue gas stream prior to being introduced into the point-source carbon capture unit.

10. The method of claim 9, wherein at least a portion of the PSA off-gas stream is combined with a fuel stream before entering the syngas generator.

11. The method of claim 1, further comprising:
introducing the raw syngas stream into a water-gas shift converter, thereby producing a shifted syngas stream,
introducing the shifted syngas stream into a pressure swing adsorption unit, thereby producing a product hydrogen stream and a PSA off-gas stream,
wherein at least a portion of the shifted syngas stream and/or at least a portion of the PSA off-gas stream is/are combined with the flue gas stream prior to being introduced into the point-source carbon capture unit.
